(19) United States
(12) Patent Application Publication
(10) Pub. No.: US 2015/0227856 A1
(43) Pub. Date: Aug. 13, 2015

(54) SYSTEMS AND METHODS FOR EVENT PLANNING

(71) Applicant: Wedding Spot, Inc., San Francisco, CA (US)

(72) Inventor: Tina Hoang-To, San Francisco, CA (US)

(21) Appl. No.: 14/619,787

(22) Filed: Feb. 11, 2015

Related U.S. Application Data
(60) Provisional application No. 61/938,672, filed on Feb. 11, 2014.

(51) Int. Cl. G06Q 10/02; G06Q 30/02

(52) U.S. Cl. CPC G06Q 10/02; G06Q 30/0283

(57) ABSTRACT

An interactive website enables a user to search for, price out, and/or compare event venues and vendors and associated prices based on multiple criteria and options selected, without having to contact the venues directly. An exemplary event is a wedding, and the venue and its vendors may offer event related services. The criteria used may be based on multiple considerations and may be dictated by, for example, a user, a venue, and/or a system or device.

### CROSS-REFERENCES TO RELATED APPLICATIONS

This application claims the benefit of U.S. Provisional Patent Application No. 61/938,672, filed Feb. 11, 2014, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The present invention is directed to an interactive website configured to enable a user to search for, price out, compare, and book appointments for event venues and vendors and associated prices based on multiple criteria and options selected, without having to contact the venues directly. The events of interest may include, but are not limited to, weddings, holiday parties, birthdays, charity/fundraiser events, corporate events, and social events, and the venue and its vendors may offer other event related services. The criteria used may be based on multiple considerations and may be dictated by, for example, a user, a venue, and/or a system or device.

Existing and competing websites provide a directory of venues and vendors with a brief description and photos, but none of the existing systems have provided detailed pricing information or algorithms for determining pricing scenarios. If a user is interested in a venue, he/she would have to fill out an inquiry form (i.e. name, phone number, email, etc.) and then wait for someone at the venue to respond back to him/her with more detailed pricing information. Often, the response time is delayed or the user receives no response at all. It would be desirable to provide an online website/system that allows users to build their ideal event by selecting various services and event options that are customized for each venue and vendor and receive an instant, itemized online pricing estimate

### BRIEF SUMMARY OF THE INVENTION

By enabling users to browse venue content, such as photos, descriptions, capacities, amenities, restrictions, and other related venue content; select certain criteria and options to build out the user's ideal event; and perform side-by-side comparisons of multiple venues for pricing based on various criteria, the preferred embodiments thereby streamlines the venue shopping and hiring/purchasing process. Consequently, users can easily shop for venues that best suit their needs, while conserving valuable resources (e.g., time, money, emotional stress, etc.) when compared to traditional venue shopping methods.

In an exemplary embodiment, a computer method for planning and budgeting a social event includes the steps of (a) a server computer serving a dedicated website accessible by a client user; (b) the server computer receiving event criteria from the client user, the event criteria including at least one of venue name, guest count, budget, style, service and location; and (c) the server computer processing the event criteria from the client user and outputting a list of venues based on the event criteria, the processing step including analyzing the event criteria and identifying alternative venues that match alternative criteria similar to or associated with the event criteria, wherein the list of venues output by the server computer includes the alternative venues. Alternative venues may include venues with characteristics that are within a predetermined range with respect to budget, guest count capacity, venue style, and location.

The method may further include (d) the server computer generating a cost estimate for the social event based on the event criteria. Step (d) may be practiced by generating the cost estimate based on at least one selected venue from the list of venues output by the server computer. Step (d) may be further practiced by receiving selections from the client user based on preferences, services, options and items to be purchased or rented from the selected venue and by generating the cost estimate according to the client user selections. Step (d) may be further practiced by displaying the selections for the client user on a dropdown list, enabling the client user to make changes, and dynamically recalculating the cost estimate as the selections are changed. The preferences, services, options and items to be purchased or rented may include services required, day of the week for the social event, season preference, guest count, duration of event, ceremony options, cocktail hour options, reception options, venue required options, and taxes and service charges required. The method may further include storing a data table of event scenarios with specific ones of the preferences, services, options and items to be purchased or rented, and step (d) may be further practiced by the server computer processing the preferences, services, options and items to be purchased or rented, accessing the data table, and identifying and compiling costs for the social event. The preferences, services, options and items to be purchased or rented may be processed to identify thresholds that affect the cost estimate, where the thresholds are accommodated when generating the cost estimate. Step (d) may be practiced by generating a price range for the cost estimate according to a cost of the client user selections between a lowest available quality and a highest available quality. The server computer may access a database of venue instructions for the selected venue, where step (d) may be practiced by generating the cost estimate based on the event criteria and with reference to the venue instructions. The server computer may enable the client user to select multiple venues from the list of venues, where the server computer displays the cost estimate and venue characteristics in a side-by-side display.

In another exemplary embodiment, a computer system for planning and budgeting a social event includes at least one user computer that accesses a dedicated website for planning and budgeting the social event, and a server computer running a server program. The at least one user computer and the server computer are interconnected by a computer network. The server computer receives event criteria from the user computer, where the event criteria includes at least one of venue name, guest count, budget, style, service and location, and where the server computer may be programmed to process the event criteria from the user computer and output a list of venues based on the event criteria. The server computer includes an alternative venue suggestion module that analyzes the event criteria and identifies alternative venues that match alternative criteria similar to or associated with the event criteria, where the list of venues output by the server computer includes the alternative venues.

In yet another exemplary embodiment, a method for planning and budgeting a wedding includes the steps of (a) a server computer serving a dedicated website accessible by a client user, the server computer storing or accessing a database of information relating venues for the wedding; (b) the server computer receiving event criteria from the client user, the event criteria including at least one of venue name, guest count, budget, style, service and location; (c) the server computer searching the database of information based on the event criteria from the client user and outputting a list of venues based on the event criteria, the outputting step including analyzing the event criteria and identifying alternative venues that match alternative criteria similar to or associated with the event criteria, wherein the list of venues output by the server computer includes the alternative venues; (d) the server computer receiving client user selected options that are venue specific; and (e) the server computer communicating with the venues to retrieve cost information for the selected options.

### BRIEF DESCRIPTION OF THE DRAWINGS

These and other aspects and advantages will be described in detail with reference to the accompanying drawings, in which:

FIG. 1 is a schematic drawing of an exemplary system for carrying out preferred embodiments of the invention;

FIG. 2 is a list view of the search results;

FIG. 3 is a map view of the search results;

FIG. 4 shows venue details after a user selects a venue from the result list;

FIG. 5 is an exemplary cost estimation form;

FIG. 6 shows a cost estimate page;

FIG. 6a shows the cost estimate page with changed event preferences;

FIG. 7 is an exemplary appointment request page;

FIG. 8 is an exemplary e-mail venue form;

FIGS. 9 and 10 show comparisons between multiple venues;

FIG. 11 is a screenshot of a rental fee table;

FIG. 12 is a screenshot of an options fee calculation table;

FIGS. 13a and 13b are screenshots of different pricing types; and

FIG. 14 shows a budget range based on guest count.

### DETAILED DESCRIPTION OF THE INVENTION

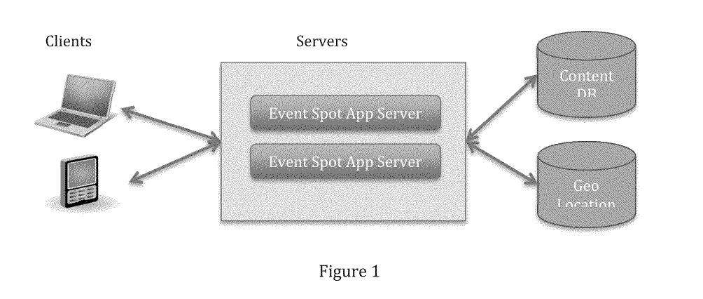

An exemplary system for performing a process of the preferred embodiments is depicted in FIG. 1. Components of the system may be communicatively coupled via, for an example, a network (e.g., the Internet) via wired and/or wireless communication couplings.

The website of the preferred embodiments may operate on/from a server that provides the website user interfaces to one or more clients. Exemplary clients include personal computers, laptop computers, tablet computers, and mobile devices (e.g., smart phones). Via the website operating on a client, a user may transmit one or more criterion to the server to begin a search for a venue. The server may then execute a search for one or more venues matching the criterion using data provided by content database and/or geo-location database. The server may also process the received criterion and/or the information stored locally and/or in the content and/or geo-location databases to make one or more determinations. Exemplary determinations include location, capacity, availability, price, options and features, whether additional information is necessary, etc. This processing can also be performed using information provided by the venue. On some occasions, the server may receive and/or process information received directly from a venue. On these occasions, the server may request information directly from the venue responsively to the receiving criteria from the user. At times, the user may save information (e.g., criteria entered, venue selections, preferences, cost estimates, favorites, appointments booked, venue comparisons, etc.).

Search for Event Venue

Initially, a user may conduct a search via the website for an event venue according to one or more criterion, such as event venues name, guest count, budget, style, service, and/or location. The server may perform the search and provide a list of multiple venues that match one or more of the criterion. At times, the list may also include recommendations or venues that match criteria similar to, or associated with, the criterion entered by the user, including but not limited to, venues with characteristics that are within a predetermined range with respect budget range, guest count capacity, venue style, and location. For example, if a user is looking for San Francisco venues that are a ballroom style for up to $30,000 in budget, the system may recommend venues that are close to that budget range and are ballroom venues or in the San Francisco area.

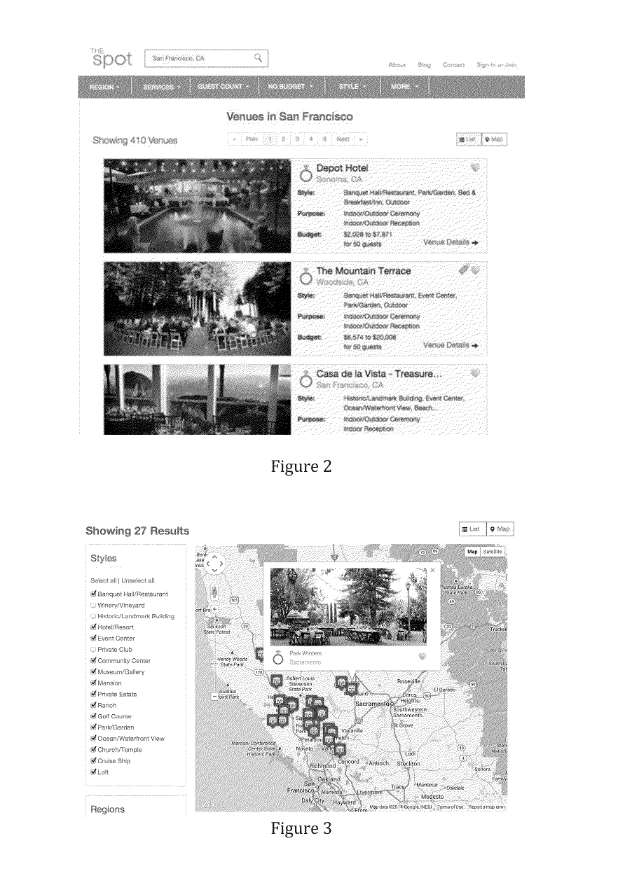

Once the search is performed, the server may provide the search results for display to the user via one or more of the client devices. In some embodiments, the website interface may provide filters as depicted in FIG. 2, provided below, to the user and the list of search results may be dynamically updated as the user applies filters to the search results.

In some embodiments, the website may provide alternate ways to view the search results, such as a list view (see FIG. 2), an icon view, a thumbnail image view, and a map view (see FIG. 3).

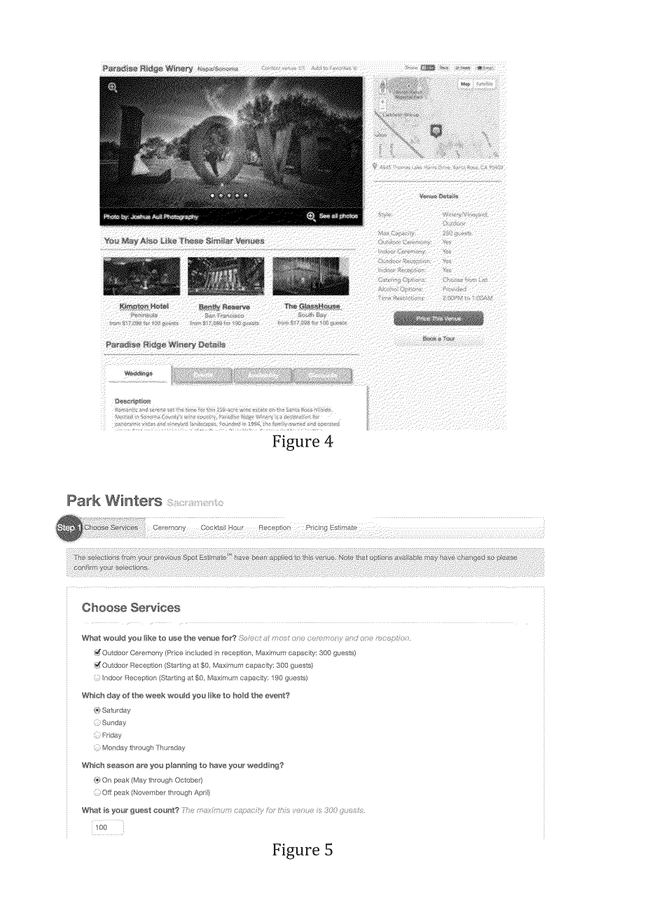

When a user selects a venue from the list, a new page including venue details may be displayed to the user via the client as provided in FIG. 4. In some instances, the venue page may be provided by the server, while in other instances, the venue page may be provided by the venue itself via, for example, a hyperlink provided in the venue list. The venue page may provide details regarding the venue, such as basic event details, an image gallery, amenities and restrictions, discounts offered, venue capacity, rental fees, and dates available.

Price Out an Event Venue

The preferred embodiments provide a cost estimation feature via a step-by-step interview process, such as the form depicted in FIG. 5, whereby a user can build his/her ideal event but selecting from various preferences, services, options and items to receive an estimate of the costs associated with holding an event (e.g., to get married) at that specified venue based on the chosen criteria. The price estimation form may provide an opportunity for a user to transmit information to the server regarding the services and/or goods to be purchased, leased, etc. for the event. Exemplary cost estimate forms may include questions regarding the intended use of the venue and/or amenities or services provided by the venue and associated vendors.

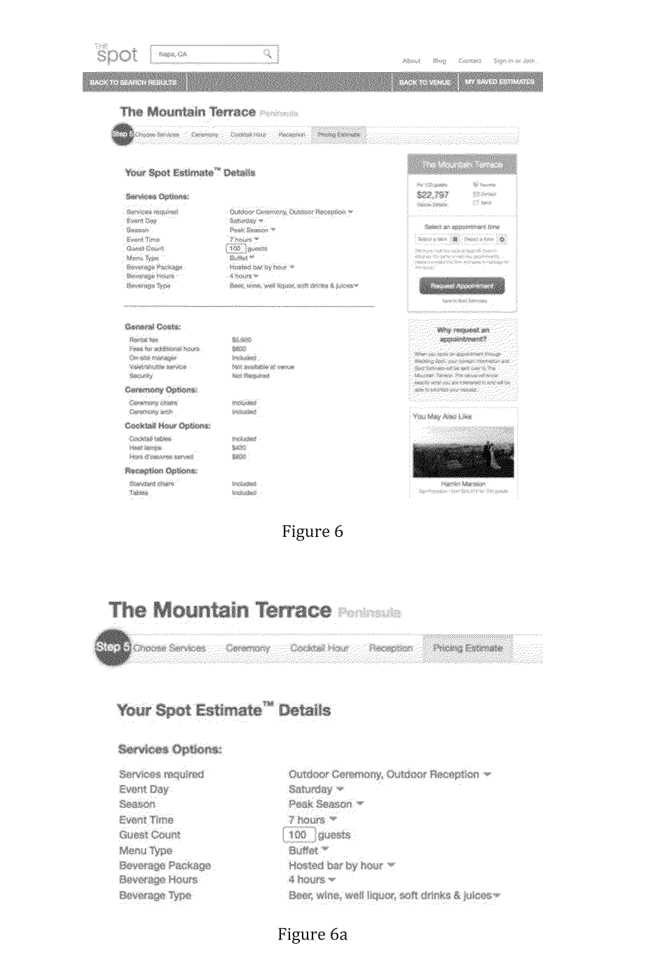

Once the form has been completed and submitted to the server, a cost estimate page, like the cost estimate page of FIG. 6, is provided to the user. Exemplary cost estimate pages may include various costs and/or fees associated with the venue, one or more of the user and/or venue criteria, and/or an event being held at the venue. The user can change the selections on the page via a dropdown list, and the cost estimate on the right hand side would be recalculated dynamically by the server and a new cost estimate will appear. The user can change items such as services required, event day, season, event time, menu type, and beverage packages, which is displayed in FIG. 6a.

Booking an Appointment

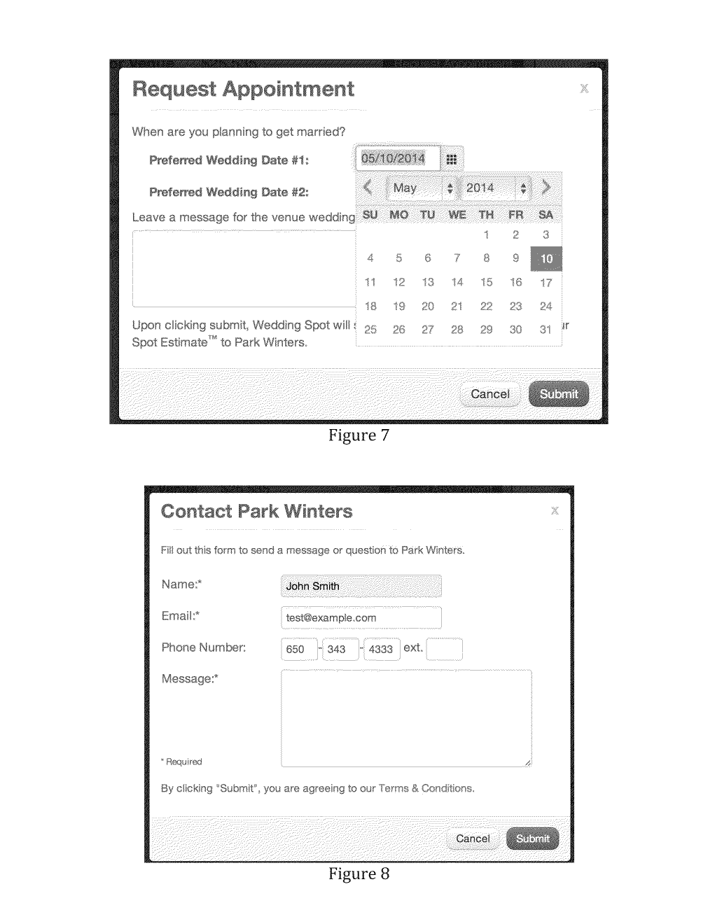

The preferred embodiments may also provide an appointment request page by which the user may indicate to the venue a desire to make an appointment for a discussion and/or visit regarding the event and/or venue. A user may book an appointment directly with the venue via the appointment request page, such as the appointment request page of FIG. 7.

At times, the user may enter information (e.g., contact information, preferred appointment times, etc.). In some embodiments, when the user submits the form, an email is sent to the venue with the user's contact information and, at times, the cost estimate.

Estimating Values

The user can also opt to contact a venue directly through the Email Venue form (see FIG. 8).

Comparing Values

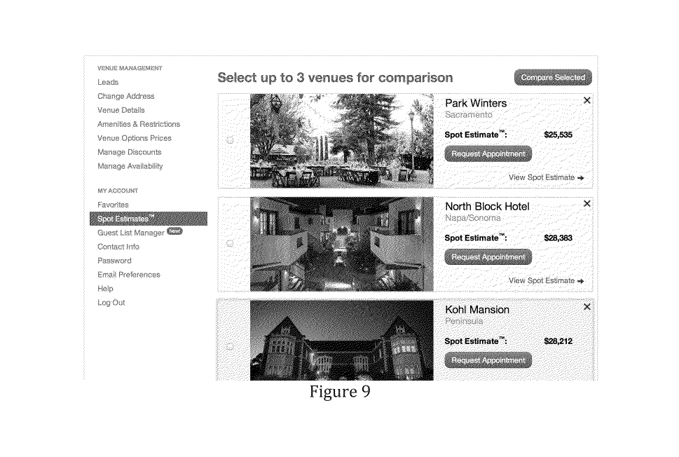

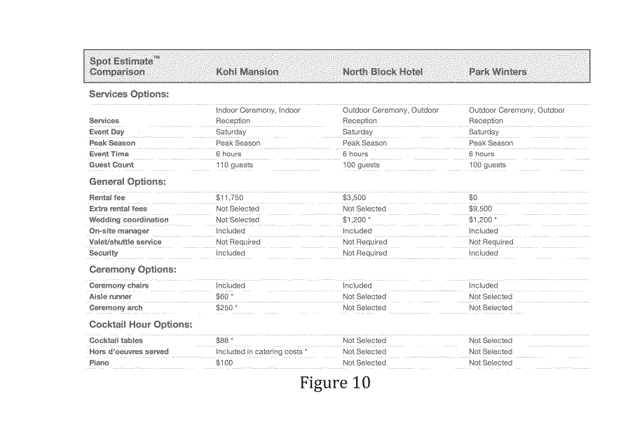

Users can also compare prices and other features for venues side-by-side by using the venue comparison feature as depicted in FIGS. 9 and 10. At times, a user may access and/or generate a side-by-side comparison via a link provided on the cost estimate page. For example, when a user has created and/or saved cost estimates, the user can access the venue comparison tool from the cost estimate page in their user accounts. Additionally or alternatively, the user can access saved information to generate saved spot estimates. In FIG. 9, the user can select up to three and potentially more venues to compare.

Cost Estimates

Cost estimates may be calculated using user criteria and user preferences for a venue and/or venue provided information. The cost estimate may be based on, for example, a combination of rental fees, food and beverage selections, food and beverage minimums, services required, venue option fees, taxes, and service charges. At times, fees and costs may be specific for each venue, as well as the option choices available and selected by the user. For example, one venue may include chairs, linens, and glassware while another may charge a fee for the same options.

A set of exemplary considerations when calculating the cost estimates include:
1. Services required
2. Day of the week for event
3. Season preference
4. Guest count
5. Number of event hours
6. Ceremony options
7. Cocktail hour options
8. Reception options
9. Venue required options
10. Taxes and service charges required

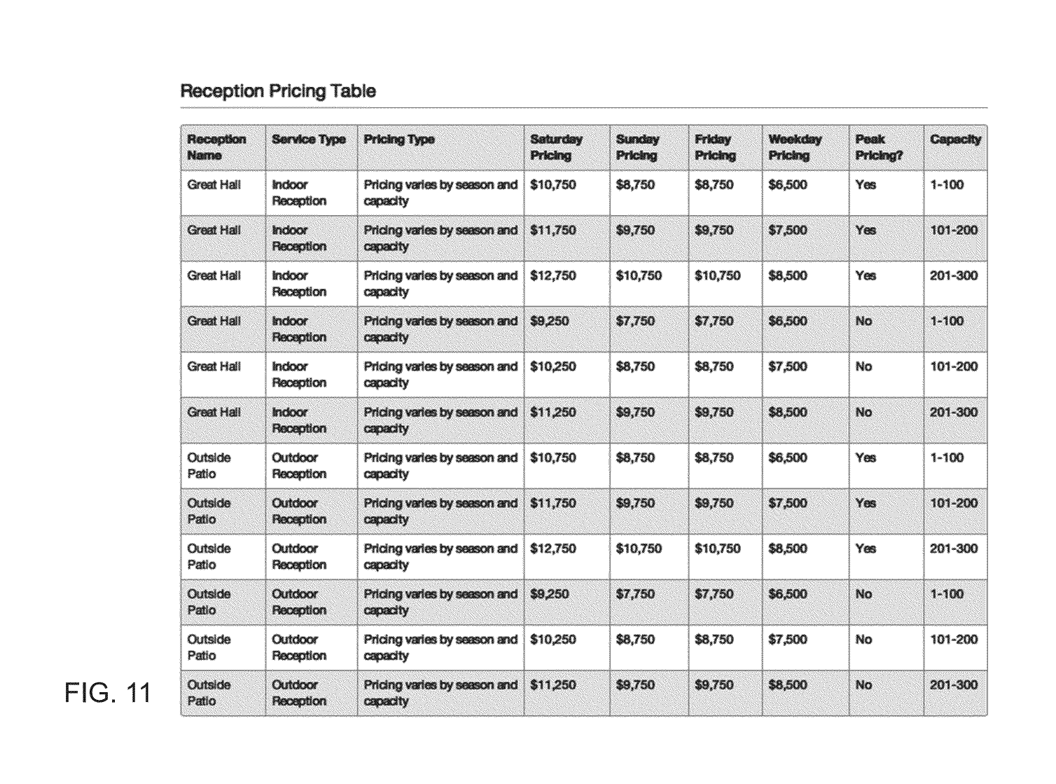

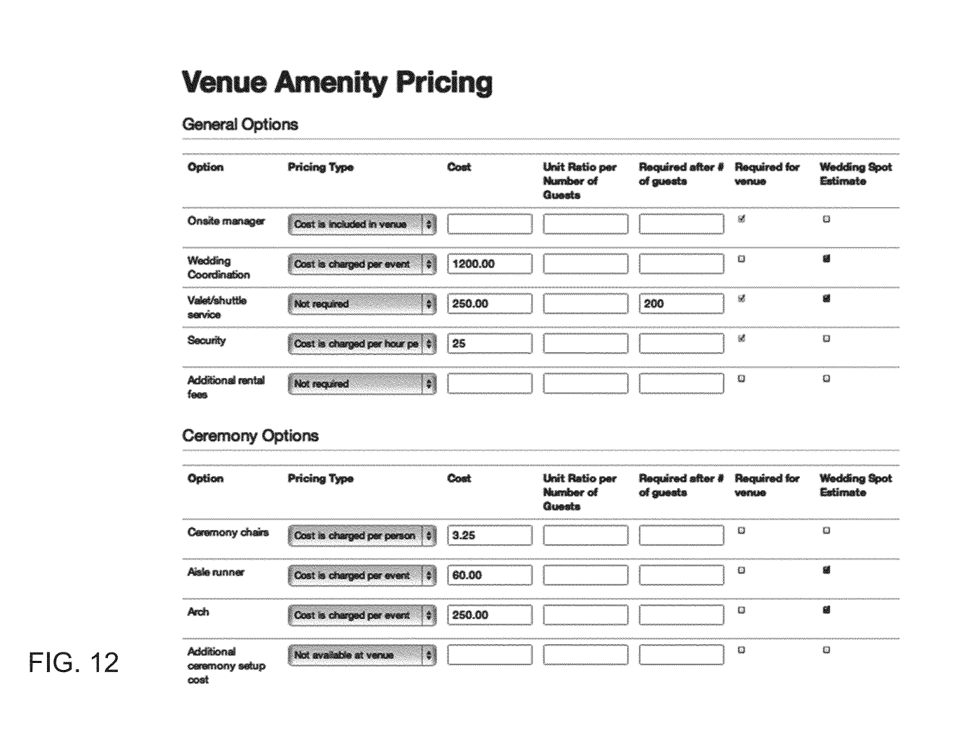

The system utilizes complex models, tables and algorithms in the database server to be able to intake a user's criteria, including but not limited to, guest count, day of event, time and season of event, event hours, various options selected by user such as menus, beverages, equipment rentals, packages, among others, and map it to the stored table(s) of prices to be able to serve the appropriate price estimate for each required scenario by item. For example, a venue may charge a different rental fee depending on various inputs for the event, including which day of the week the event is held on, which season is of interest, which services are selected, and lastly, how many people are expected to be at the event. See FIG. 11. The system intakes the necessary user selections and intelligently serves back to the user the appropriate rental fee for that specific scenario. Other costs and price estimates associated with each event are calculated based on a similar approach. Other costs for the event may be triggered or calculated based on various pricing types and guest count thresholds. For example, you may not need to hire extra security below 150 guests, but a $25/hour security expense is required after 150 guests. In another example, ceremony chairs may be calculated based on guest count at a cost of $3.25 per person. The present embodiments include a set of tables and algorithms that can be manipulated to serve a number of different event scenarios and costs based on user selections. FIG. 12 is a screenshot of an options fee calculation table.

Furthermore, the cost of services provided by the venue may also be dependent upon various characteristics of the event and options selected by the user. For example, a cost of serving staff may vary depending on the number of event hours, the time of day for the event, and the type of services provided.

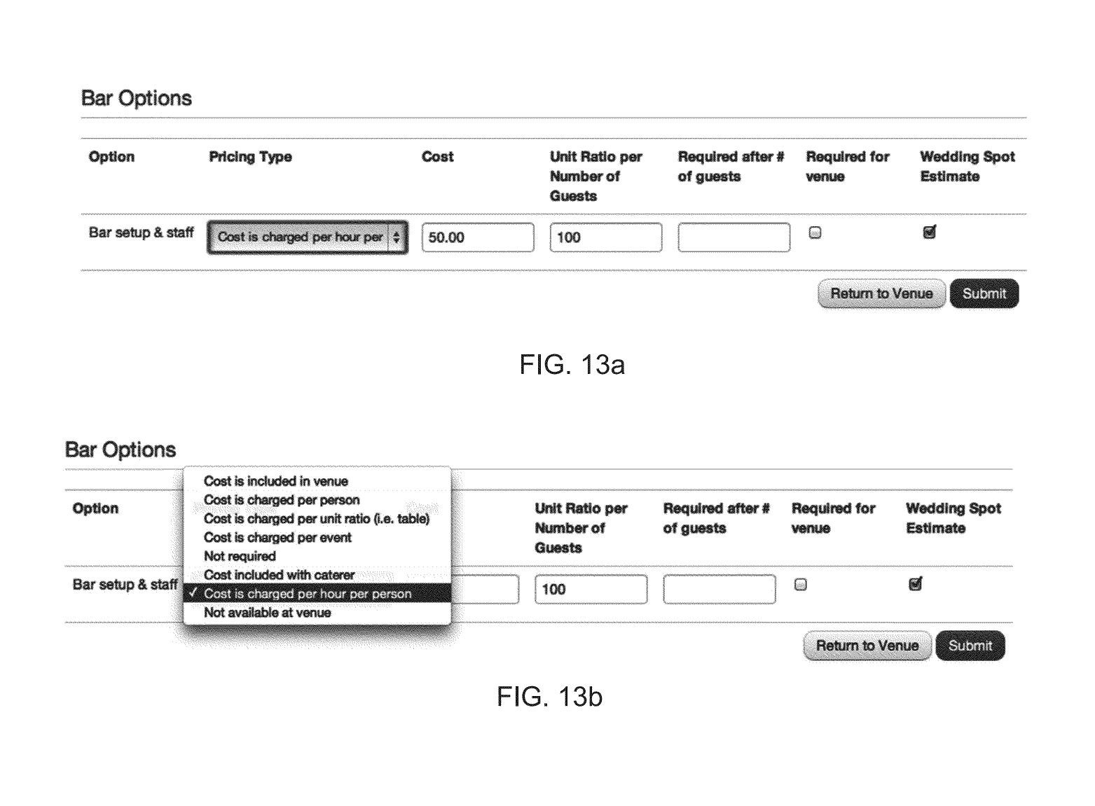

Ultimately, the developed algorithm applies the user inputs to the venue's instructions on how to charge for each option to generate the cost estimate. Since there are various pricing types and ways in which costs are triggered, the system relies on the venue to provide guidance for how to calculate the cost estimate. For example, in the case of bartending staff, it could be (a) a flat fee for the entire event (e.g. $500 bartending fee for event); (b) a cost per hour (e.g. $25/hour per bartender); or (c) a cost per hour based on a certain ratio of guests (e.g. $25/hour per bartender, one bartender for every 50 guests). See FIGS. 13a and 13b showing screenshots of different pricing types.

Budget Ranges

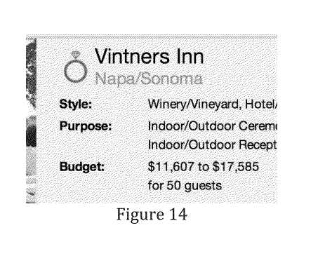

When searching for venues, the system shows a unique budget range for each venue based on the desired guest count, such as the budget displayed in FIG. 14.

The budget range is pre-calculated by selecting a low and high end of user preferences and funneling the inputs through the cost estimate algorithm. This provides an accurate range for how much an event can cost at a specific venue depending on options selected.

The preferred embodiments provide the first online site that allows you to search for price and compare multiple event venues. Working directly with venues, the preferred embodiments gather all the information required to enable you to easily search for venues based on, for example, budget, location, style, and guest count. The system then “builds out” your ideal event day by selecting specific services and options to see a price estimate.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A computer method for planning and budgeting a social event, the method comprising:
(a) a server computer serving a dedicated website accessible by a client user;
(b) the server computer receiving event criteria from the client user, the event criteria including at least one of venue name, guest count, budget, style, service and location; and
(c) the server computer processing the event criteria from the client user and outputting a list of venues based on the event criteria, the processing step including analyzing the event criteria and identifying alternative venues that match alternative criteria similar to or associated with the event criteria, wherein the list of venues output by the server computer includes the alternative venues.

2. A computer method according to claim 1, further comprising:
(d) the server computer generating a cost estimate for the social event based on the event criteria.

3. A computer method according to claim 2, where step (d) is practiced by generating the cost estimate based on at least one selected venue from the list of venues output by the server computer.

4. A computer method according to claim 3, wherein step (d) is further practiced by receiving selections from the client user based on preferences, services, options and items to be purchased or rented from the selected venue and by generating the cost estimate according to the client user selections.

5. A computer method according to claim 4, wherein step (d) is further practiced by displaying the selections for the client user on a dropdown list, enabling the client user to make changes, and dynamically recalculating the cost estimate as the selections are changed.

6. A computer method according to claim 4, wherein the preferences, services, options and items to be purchased or rented comprise services required, day of the week for the social event, season preference, guest count, duration of event, ceremony options, cocktail hour options, reception options, venue required options, and taxes and service charges required.

7. A computer method according to claim 6, further comprising storing a data table of event scenarios with specific ones of the preferences, services, options and items to be purchased or rented, and wherein step (d) is further practiced by the server computer processing the preferences, services, options and items to be purchased or rented, accessing the data table, and identifying and compiling costs for the social event.

8. A computer method according to claim 4, wherein step (d) is practiced by generating a price range for the cost estimate according to a cost of the client user selections between a lowest available quality and a highest available quality.

9. A computer method according to claim 4, wherein the preferences, services, options and items to be purchased or rented are processed to identify thresholds that affect the cost estimate, and wherein the thresholds are accommodated when generating the cost estimate.

10. A computer method according to claim 3, wherein the server computer accesses a database of venue instructions for the selected venue, and wherein step (d) is practiced by generating the cost estimate based on the event criteria and with reference to the venue instructions.

11. A computer method according to claim 2, further comprising the server computer enabling the client user to select multiple venues from the list of venues, and the server computer displaying the cost estimate and venue characteristics in a side-by-side display.

12. A computer method according to claim 1, wherein the step of identifying alternative venues that match alternative criteria similar to or associated with the event criteria is practiced by identifying venues with characteristics that are within a predetermined range with respect to budget, guest count capacity, venue style, and location.

13. A computer system for planning and budgeting a social event, the computer system comprising:
at least one user computer that accesses a dedicated website for planning and budgeting the social event; and
a server computer running a server program, the at least one user computer and the server computer being interconnected by a computer network, the server computer receiving event criteria from the user computer, the event criteria including at least one of venue name, guest count, budget, style, service and location, wherein the server computer is programmed to process the event criteria from the user computer and output a list of venues based on the event criteria, the server computer including an alternative venue suggestion module that analyzes the event criteria and identifies alternative venues that match alternative criteria similar to or associated with the event criteria, wherein the list of venues output by the server computer includes the alternative venues.

14. A computer system according to claim 13, further comprising a budget module that generates a cost estimate for the social event based on the event criteria.

15. A computer system according to claim 14, wherein the budget module generates the cost estimate based on at least one selected venue from the list of venues output by the server computer.

16. A computer system according to claim 15, wherein the server computer receives selections from the user computer based on preferences, services, options and items to be purchased or rented from the selected venue, and wherein the budget module generates the cost estimate according to the client user selections.

17. A computer system according to claim 16, further comprising a menu display module that displays the selections on the user computer on a dropdown list, and a dynamic pricing module that dynamically recalculates the cost estimate as the selections are changed.

18. A method for planning and budgeting a wedding, the method comprising:
(a) a server computer serving a dedicated website accessible by a client user, the server computer storing or accessing a database of information relating venues for the wedding;
(b) the server computer receiving event criteria from the client user, the event criteria including at least one of venue name, guest count, budget, style, service and location;
(c) the server computer searching the database of information based on the event criteria from the client user and outputting a list of venues based on the event criteria, the outputting step including analyzing the event criteria and identifying alternative venues that match alternative criteria similar to or associated with the event criteria, wherein the list of venues output by the server computer includes the alternative venues;
(d) the server computer receiving client user selected options that are venue specific; and
(e) the server computer communicating with the venues to retrieve cost information for the selected options.
